(19) United States
(12) Patent Application Publication
(10) Pub. No.: US 2007/0208955 A1
(43) Pub. Date: Sep. 6, 2007

(54) INTEGRATED CIRCUIT AND METHOD FOR MANUFACTURING WAFER AND INTEGRATED CIRCUIT

(75) Inventors: Yoshihiro Okabe, Sendai-shi (JP); Hidekazu Itoh, Saitama-shi (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/680,629

(22) Filed: Mar. 1, 2007

(30) Foreign Application Priority Data
Mar. 1, 2006 (JP) 2006-55092

(51) Int. Cl. G06F 12/14

(52) U.S. Cl. 713/194

(57) ABSTRACT

An integrated circuit, wafer, and method for manufacturing an integrated circuit that inhibits the analysis of the circuit via reverse engineering. An integrated circuit includes a target circuit and a reverse engineering prevention circuit. The reverse engineering prevention circuit includes a decryption circuit, a nonvolatile memory, and an automatic read/enable signal generation circuit. When provided with a decoding enable signal and decoding data, the decryption circuit decodes data to perform authentication. When the authentication is successful, the decryption circuit outputs a memory enable signal. When provided with the memory enable signal, the nonvolatile memory enables the writing of data. The automatic read/enable signal generation circuit acquires the data written to the nonvolatile memory to generate a circuit enable signal, which is provided to the target circuit to activate the target circuit.

### BACKGROUND OF THE INVENTION

The present invention relates to an integrated circuit and a method for manufacturing a wafer and an integrated circuit that prevent the contents of a circuit from being discovered through analysis.

In an integrated circuit, a plurality of integrated circuit chips are often simultaneously formed on the same wafer to improve productivity. More specifically, a plurality of elements and wiring patterns, which function as integrated circuits, are formed on a wafer Then, a dicing process is performed to divide the wafer into a plurality of chips, which function as integrated circuits. The divided chips are connected to external terminals and then sealed during an assembly process. This completes an integrated circuit (IC) product.

Integrated circuits may be used in security devices or amusement machines. It is desirable that the contents of such integrated circuits be prevented from being decrypted and modified, Techniques for preventing the contents of such an integrated circuit from being modified has been disclosed (for example, refer to Japanese Laid-Open Patent Publication No. 2003-47746, FIG. 2).

In the technique disclosed in Japanese Laid-Open Patent Publication No. 2003-47746, an amusement machine uses a game control program, which is encoded beforehand, and ROMs having serial numbers. After installation of the amusement game is completed, the serial numbers are transmitted to a data collection management device. The data collection management device then transmits a decoding key, which is associated with the received serial numbers, and a decoding program to the amusement machine. The amusement machine uses the received decoding key and decoding program to decode the encoded game control program, which is then stored in a memory.

In the technique described in Japanese Laid-Open Patent Publication No. 2003-47746, the serial numbers are used as a security measure. After IC products are assembled and completed, the serial numbers are recorded on integrated circuits. In other words, in a stage in which the integrated circuits are formed on a wafer, the integrated circuits are not secure. In such a state, data may be written to the integrated circuits. Further, reverse engineering may be carried out on the integrated circuits. Thus, if a wafer on which the integrated circuits are formed is stolen or erroneously delivered to an unintended destination, the contents of the integrated circuit may be decrypted or modified through reverse engineering.

### SUMMARY OF THE INVENTION

The present invention provides an integrated circuit and a method for manufacturing a wafer and an integrated circuit that prevent a third person from discovering the contents of a circuit by making it difficult to analyze a circuit through reverse engineering even when a wafer on which integrated circuits are formed is stolen.

One aspect of the present invention is an integrated circuit including a target circuit for performing a predetermined operation. A reverse engineering prevention circuit is formed integrally with the target circuit. The reverse engineering prevention circuit is connected to the target circuit and generates a circuit enable signal provided to the target circuit. The target circuit functions normally only when provided with a predetermined circuit enable signal from the reverse engineering prevention circuit and functions to perform a dummy operation otherwise.

A further aspect of the present invention is a wafer including the above integrated circuit.

Another aspect of the present invention is a method for manufacturing an integrated circuit including a target circuit for performing a predetermined operation and a reverse engineering prevention circuit connected to the target circuit to generate a circuit enable signal provided to the target circuit. The method includes forming the reverse engineering prevention circuit on a wafer so that the target circuit becomes active only when the circuit enable signal from the reverse engineering prevention circuit is a predetermined signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing integrated circuits and a wafer according to a preferred embodiment of the present invention; and

FIG. 2 is a flowchart showing the procedures taken to manufacture and inspect an integrated circuit in the preferred embodiment.

### DETAILED DESCRIPTION OF THE PREFERRED EMBODIMENTS

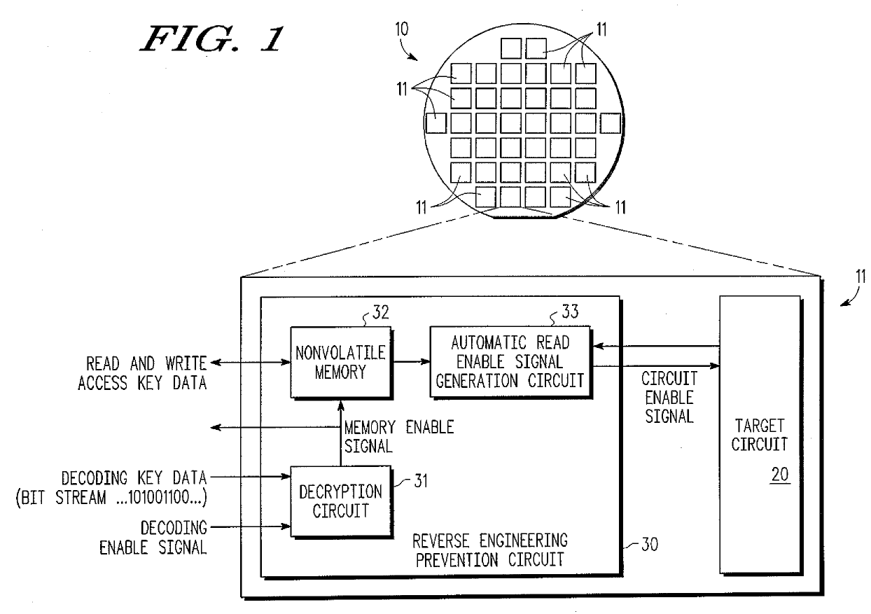

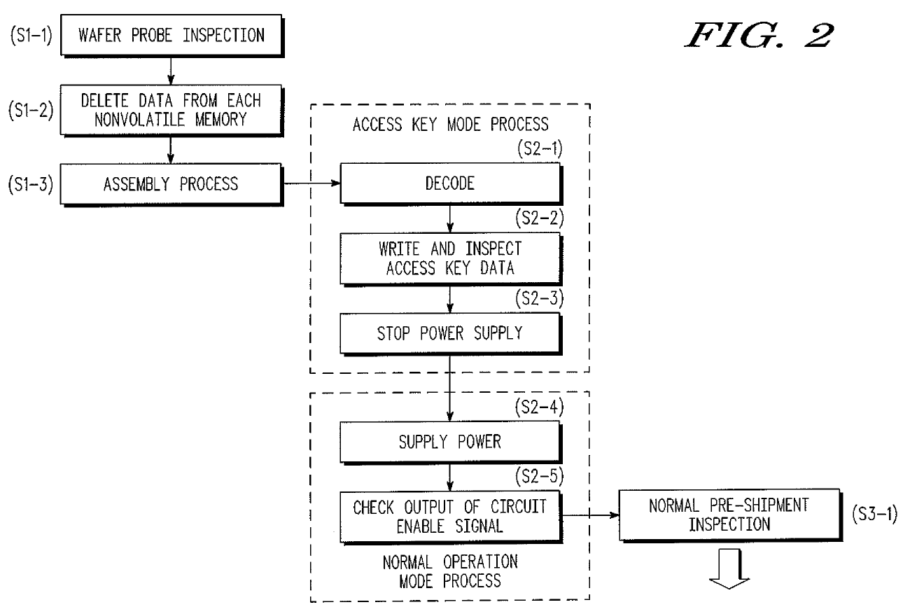

A preferred embodiment of the present invention will now be discussed with reference to FIGS. 1 and 2. As shown in FIG. 1, a wafer 10 has a plurality of integrated circuits 11 including predetermined wiring patterns formed thereon. Each integrated circuit 11 includes a target circuit 20 and a reverse engineering prevention circuit 30.

The target circuit 20 stores a function program, which is used to perform a predetermined process, and a security identification code, which is used to prevent the function of a program from being analyzed. For example, when the integrated circuit 11 is used in an amusement machine, a game control program and data including a known authentication program for preventing the program from being analyzed are recorded in the target circuit 20. In the preferred embodiment, the target circuit 20 becomes active when a circuit enable signal is received from the reverse engineering prevention circuit 30. In this state, the target circuit 20 executes a predetermined process. Further, data may be freely read from or written to the target circuit 20.

The reverse engineering prevention circuit 30 includes a decryption circuit 31 functioning as an authentication circuit, a nonvolatile memory 32, and an automatic read/enable signal generation circuit 33. The decryption circuit 31, nonvolatile memory 32, and automatic read/enable signal generation circuit 33 are each formed integrally with the target circuit 20.

The decryption circuit 31, which holds authentication data and encoded authentication data, is provided with a decoding enable signal and decoding key data from an external device. The decoding enable signal is provided to the decryption circuit 31 to enable decoding. The decoding key data is provided to the decryption circuit 31 through a bit stream. When the decryption circuit 31 is provided with the decoding enable signal and the decoding key data, the decryption circuit 31 uses the decoding key data to decode the held encoded authentication data. Then, the decryption circuit 31 compares the decoded data with authentication data to authenticate the decoded data. The authentication is completed when the decoded data is identical to the authentication data. Then, the decryption circuit 31 performs a calculation with the authentication data to generate a memory enable signal, which is provided to the nonvolatile memory 32. In the preferred embodiment, the decryption circuit 31 is capable of transmitting the generated memory enable signal to an external device via an external terminal (not shown).

If the decoded data is not identical to the authentication data, the decryption circuit 31 stops further processing. In such a case, the decryption circuit 31 does not provide the nonvolatile memory 32 with the memory enable signal. Thus, the nonvolatile memory 32 remains inactive and data cannot be read from or written to the nonvolatile memory 32.

The nonvolatile memory 32 may be formed by a known device such as an electronically erasable programmable read-only memory (EEPROM). The nonvolatile memory 32 is set so that it becomes active when provided with the memory enable signal from the decryption circuit 31. When the nonvolatile memory 32 is provided with the memory enable signal and is active, data may be written to or read from the nonvolatile memory 32 by an external device. In such a case, access key data may be written to the nonvolatile memory 32 to enable activation of the target circuit 20.

The automatic read/enable signal generation circuit 33 reads the access key data written to the nonvolatile memory 32 regardless of the state of the memory enable signal. The automatic read/enable signal generation circuit 33 receives a signal including feedback information related with the state of the target circuit 20 from the target circuit 20. In this case, the automatic read/enable signal generation circuit 33 performs a predetermined calculation on the read access key data while referring to the state feedback information to generate a predetermined signal, which is provided to the target circuit 20. When the target circuit 20 is provided with the correct circuit enable signal, the target circuit 20 is activated and normal operations such as data reading and writing are performed.

In the preferred embodiment, the automatic read/enable signal generation circuit 33 performs the predetermined calculation even when the access key data cannot be read from the nonvolatile memory 32 or when the read access key data is not correct. For example, the target circuit 20 may not be provided with the circuit enable signal or may be provided with an incorrect circuit enable signal. In such cases, the target circuit 20 performs a dummy operation that differs from the operation performed when provided with the correct circuit enable signal.

A method for manufacturing a device including the integrated circuit 11 of the present invention will now be discussed with reference to FIG. 2.

A plurality of the integrated circuits 11, each including the target circuit 20 and the reverse engineering prevention circuit 30, are formed on the wafer 10 as shown in FIG. 1 through a known pattern formation technique. Then, a known probe test (conduction test) is performed on the wafer 10, on which the integrated circuits 11 are formed (step S1-1). When conducting the probe test, a controller for an inspection device performs the following processes on each integrated circuit 11.

The controller of the inspection device provides the decryption circuit 31 with the decoding enable signal to activate the decryption circuit 31. Further, the decryption circuit 31 is provided with the decoding key data through a bit stream. The decryption circuit 31 then uses the decoding key data to decode and authenticate the encoded authentication data. When the decoded authentication data is identical to the stored authentication data, the decryption circuit 31 generates the memory enable signal, which is provided to the inspection device via an external terminal and to the nonvolatile memory 32.

When receiving the memory enable signal from the decryption circuit 31, the controller of the inspection device writes the access key data to the nonvolatile memory 32. After the access key data is written to the nonvolatile memory 32, the automatic read/enable signal generation circuit 33 reads the access key data from the nonvolatile memory 32, generates the circuit enable signal, and provides the target circuit 20 with the circuit enable signal. This activates the target circuit 20. Then, the controller of the inspection device provides the target circuit 20 with a signal for conducting a probe test that distinguishes abnormal products from normal products.

Upon completion of the probe test, the controller of the inspection device deletes the data written to the nonvolatile memory 32 of each reverse engineering prevention circuit 30 on the wafer 10 (step S1-2).

The wafer 10 processed in this manner is then diced. The integrated circuits 11 that have been determined as being normal then undergo an assembly process (step S1-3). In the assembly process, bonding and packaging are performed through known methods.

When the assembly process is completed, the integrated circuits 11 undergo another inspection. The reverse engineering prevention circuit 30 of each integrated circuit 11 that has been determined as being normal is provided with the decoding enable signal, the decoding key data, and the access key data to generate the circuit enable signal. The circuit enable signal is then provided to the target circuit 20.

Here, the inspection device executes an access key mode process and a normal operation mode process on the integrated circuit 11 to inactivate the reverse engineering prevention circuit 30. These processes will now be described in detail.

In the access key mode process, the encoded data stored in the decryption circuit 31 is decoded (step S2-1). In this case, the decoding enable signal and decoding key data is provided to the decryption circuit 31. As a result, the decryption circuit 31 generates the memory enable signal, which is provided to the nonvolatile memory 32.

Next, the access key data is written and inspected (step S2-2). The inspection device writes the access key data to the nonvolatile memory 32, which is provided with the memory enable signal from the decryption circuit 31. As a result, the automatic read/enable circuit 33 performs a calculation using the written access key data to provide the target circuit 20 with the circuit enable signal. This activates the target circuit 20. An inspection for determining whether or not the access key data has been written may be performed, for example, by determining whether or not the circuit enable signal is detected. If the signal is detected, and the inspection is completed, the supply of power to the integrated circuit 11 is stopped (step S2-3).

Then, the normal operation mode process is performed on the integrated circuit 11, which has undergone the access key mode processing. In the normal operation mode process, the integrated circuit 11 is first supplied with power (step S2-4). Then, it is checked whether or not the circuit enable signal is output to the target circuit 20 from the reverse engineering prevention circuit 30 even though the decryption circuit 31 is not provided with a signal (step S2-5).

When the circuit enable signal is output, a normal pre-shipment inspection is performed (step S3-1). More specifically, a final test such as a reliability inspection is performed. Integrated circuits 11 that pass this inspection are shipped out of the factory.

The preferred embodiment has the advantages described below.

In the preferred embodiment, the integrated circuit 11 includes the target circuit 20, which includes a function program for performing a predetermined process. The target circuit 20 is activated when the predetermined circuit enable signal is received from the reverse engineering prevention circuit 30. To generate the circuit enable signal, the reverse engineering prevention circuit 30 must be operated. Accordingly, when the reverse engineering prevention circuit 30 cannot be operated, analysis such as reverse engineering cannot be performed on the target circuit 20. This prevents the contents of the target circuit 20 from being discovered.

Further, when the integrated circuit 11 is formed on the wafer 10, the reverse engineering prevention circuit 30 is formed together with the target circuit 20. Thus, for example, even if the entire wafer 10 is stolen, the reverse engineering prevention circuit 30 prevents the target circuit 20 from being analyzed. This makes reverse engineering and modification of the contents of the integrated circuit 11 difficult.

In the preferred embodiment, the reverse engineering prevention circuit 30 includes the nonvolatile memory 32, to which the access key data is written, and the automatic read/enable signal generation circuit 33, which generates the circuit enable signal using the written access key data. Thus, to generate the correct circuit enable signal, the correct access key data and the processing performed by the automatic read/enable signal generation circuit 33, which uses the access key data, must both be understood. Accordingly, it is difficult to analyze the reverse engineering prevention circuit 30 and generate the circuit enable signal. This prevents the target circuit 20 from being reverse engineered or analyzed.

In the preferred embodiment, the reverse engineering prevention circuit 30 includes the decryption circuit 31, which provides the nonvolatile memory 32 with the memory enable signal. When receiving the decoding enable signal and the decoding key data, the decryption circuit 31 uses the decoding key data to decode the stored encoded data and perform authentication by determining whether the decoded data is identical to the authentication data. When the authentication is completed, the decryption circuit 31 uses the authentication data to generate the memory enable signal. Thus, as long as the decryption circuit 31 cannot perform the decoding, data cannot be written to the nonvolatile memory 32 and the memory enable signal cannot be generated. This makes the analysis of the integrated circuit 11 further difficult.

In the preferred embodiment, the reverse engineering prevention circuit 30 writes the access key data to the nonvolatile memory 32. When conducting the probe test, the controller of the inspection device provides the decryption circuit 31 with the decoding enable signal and the decoding key data to generate the memory enable signal, which is provided to the nonvolatile memory 32.

Further, the access key data is written during the access key mode process, which is performed after the assembly process. Subsequently, the reverse engineering prevention circuit 30 constantly generates the circuit enable signal. Accordingly, the reverse engineering prevention circuit 30 is invalidated. Thus, even if the reverse engineering prevention circuit 30 exists, for example, a customer supplied with the integrated circuit may freely perform processes, such as the writing of data, on the target circuit 20.

Further, when the nonvolatile memory 32 is provided with the memory enable signal, the access key data is written to the nonvolatile memory 32. Accordingly, during an inspection, an operation check may be performed by providing the circuit enable signal to the target circuit 20 to activate the target circuit 20.

Additionally, when the probe test is completed, the controller of the inspection device deletes the data written to each nonvolatile memory 32 (step S1-2). Thus, after the inspection is completed and the access key data is deleted, the reverse engineering prevention circuit 30 functions effectively. This prevents the target circuit 20 from being reverse engineered. Therefore, the contents of the target circuit 20 cannot be analyzed.

In the preferred embodiment, during the access key mode process, the supply of power is stopped (step S2-3). Then, in the normal operation mode process, power is supplied (step S2-4) and the output of the circuit enable signal is checked (step S2-5). Thus, the integrated circuit 11 is shipped out of the factory after checking whether the target circuit 20 is in a constantly validated state even though the supply of power is once stopped. This enables, for example, a customer to use the target circuit 20 in the same manner as it has been used in the prior art.

It should be apparent to those skilled in the art that the present invention may be embodied in many other specific forms without departing from the spirit or scope of the invention. Particularly, it should be understood that the present invention may be embodied in the following forms.

In the preferred embodiment, the reverse engineering prevention circuit 30 includes the decryption circuit 31, the nonvolatile memory 32, and the automatic read/enable signal generation circuit 33. However, the reverse engineering prevention circuit 30 is not limited to such a configuration as long as it is formed together with the target circuit 20 and is capable of generating the circuit enable signal that activates the target circuit 20. For example, the decryption circuit 31 may be eliminated from the reverse engineering prevention circuit 30 and data may be freely written to the nonvolatile memory 32.

In the preferred embodiment, the automatic read/enable signal generation circuit 33 may generate any number of circuit enable signals or be fed back with any number of signals related with the state of the target circuit 20. By increasing the number of these signals and making it necessary to refer to the feedback from the target circuit 20, it would become difficult to analyze the structure of the target circuit even when the wafer is sliced to examine lower layers with a microscope to check the wiring layout of the wafer.

In the preferred embodiment, a function program, which is for performing a predetermined process, and a security identification code are recorded on the target circuit 20. However, the target circuit 20 is not limited in such a manner and may store any kind of data that requires security.

The present examples and embodiments are to be considered as illustrative and not restrictive, and the invention is not to be limited to the details given herein, but may be modified-within the scope and equivalence of the appended claims.

1. An integrated circuit comprising:
a target circuit for performing a predetermined operation; and
a reverse engineering prevention circuit formed integrally with the target circuit;
wherein the reverse engineering prevention circuit is connected to the target circuit and generates a circuit enable signal provided to the target circuit; and
the target circuit functions normally only when provided with a predetermined circuit enable signal from the reverse engineering prevention circuit and functions to perform a dummy operation otherwise.

2. The integrated circuit according to claim 1, wherein the reverse engineering prevention circuit includes:
a memory for storing access key data; and
an automatic read circuit for generating the circuit enable signal with the access key data when data is written to the memory.

3. The integrated circuit according to claim 2, wherein the memory is a nonvolatile memory.

4. The integrated circuit according to claim 3, wherein the reverse engineering prevention circuit further includes:
a decryption circuit that provides the memory with a memory enable signal for enabling data to be written to or read from the memory, the decryption circuit storing authentication data and encoded authentication data, which is generated by encoding the authentication data, and when the decryption circuit receives a decoding enable signal, which activates the decryption circuit, and decoding key data, the decryption circuit uses the decoding key data to decode the encoded authentication data and provides the memory with the memory enable signal when the encoded authentication data that is decoded is identical to the authentication data.

5. A wafer comprising:
the integrated circuit according to claim 1.

6. A method for manufacturing an integrated circuit including a target circuit for performing a predetermined operation and a reverse engineering prevention circuit connected to the target circuit to generate a circuit enable signal provided to the target circuit, the method comprising:
forming the reverse engineering prevention circuit on a wafer so that the target circuit becomes active only when the circuit enable signal from the reverse engineering prevention circuit is a predetermined signal.

7. The method according to claim 6, wherein the reverse engineering prevention circuit includes a nonvolatile memory for storing access key data, an automatic rear circuit for generating the circuit enable signal based on the access key data written to the nonvolatile memory and providing the target circuit with the circuit enable signal, and an authentication circuit that performs authentication to generate a memory enable signal enabling data to be written to or read from the nonvolatile memory, the method further comprising:
an inspection step started by writing and storing the access key data to the nonvolatile memory after the authentication circuit is provided with authentication data to activate the nonvolatile memory and ended by deleting the access key data recorded on the nonvolatile memory.

8. The method according to claim 7, further comprising:
an access key mode processing step for storing the access key data to the nonvolatile memory after assembly but before shipment of the integrated circuit.
